(19) United States
(12) Patent Application Publication
(10) Pub. No.: US 2026/0288628 A1
(43) Pub. Date: Sep. 24, 2026

(54) DEBUGGING INTEGRATED SOFTWARE ARTIFACTS WITH CONFIDENTIAL COMPONENTS IN COLLABORATIVE DEVELOPMENT ENVIRONMENTS

(71) Applicant: Robert Bosch GmbH, Stuttgart (DE)

(72) Inventors: Sebastian BECKER, Ludwigsburg (DE); Sven TRIEFLINGER, Renningen (DE); Pradeep M. PAPPACHAN, Pittsburgh, PA (US); Shalabh JAIN, Pittsburgh, PA (US); Stefan GEHRER, Pittsburgh, PA (US)

(21) Appl. No.: 19/087,765

(22) Filed: Mar. 24, 2025

(51) Int. Cl. G06F 11/3698; G06F 11/30; G06F 11/3604; G06F 11/362; G06F 21/53; G06F 21/60; G06F 21/62; G06Q 10/101

(52) U.S. Cl. CPC G06F 11/3698; G06F 11/3072; G06F 11/3604; G06F 11/362; G06F 21/53; G06F 21/602; G06F 21/6209; G06Q 10/101

(57) ABSTRACT

A system configured to perform a collaborative debugging process in a multi-owned computing environment includes one or more computing devices configured to establish a confidential computing system using a trusted execution environment (TEE), the confidential computing system storing at least a portion of a software build artifact, initiate, by a debugging system on the confidential computing system as established in the TEE, the debugging process. The debugging process is configured to enable debugging of the software build artifact by a plurality of participating parties (PPs), each of the PPs being associated with a different portion of the software build artifact, and execute the debugging process using the debugging system on the confidential computing system.

### TECHNICAL FIELD

The present disclosure relates to debugging systems and methods for multi-party computing environments.

### BACKGROUND

Various collaborative processes (e.g., digital cleanrooms, collaborative learning for AI, etc.) involve multiple entities/parties. In one example, distributed software integrations and build processes may involve multiple entities/parties independently developing and testing respective portions (e.g., software modules) of a software application and then integrating the various software modules to build the application within a computing environment (e.g., as implemented in a cloud computing system). For example, in the automotive industry, original equipment manufacturers (OEMs) and suppliers may collaborate to develop software applications that are executed on embedded systems inside vehicles. This model of collaboration may include each entity separately developing and testing some portion of the software application to defined specifications (e.g., respective requirements, application program interface (API) specifications, etc.) and eventually integrating the various software portions before final testing and implementation. In some examples, a computing environment is configured to be set up and operated by a single party or entity with full administrative power.

### SUMMARY

A system configured to perform a collaborative debugging process in a multi-owned computing environment includes one or more computing devices configured to establish a confidential computing system using a trusted execution environment (TEE), the confidential computing system storing at least a portion of a software build artifact, initiate, by a debugging system on the confidential computing system as established in the TEE, the debugging process. The debugging process is configured to enable debugging of the software build artifact by a plurality of participating parties (PPs), each of the PPs being associated with a different portion of the software build artifact, and execute the debugging process using the debugging system on the confidential computing system. Executing the debugging process includes providing, from the debugging system on the confidential computing system, respective portions of debugging information to the PPs via respective debugging client interfaces, each of the respective portions of the debugging information being associated with a respective different portion of the software build artifact, and receiving, at the debugging system from the respective debugging client interfaces, inputs associated with the debugging process being performed on the respective portions of the debugging information.

Other embodiments include various methods, systems, one or more processors or processing devices, or other circuitry configured to implement functions corresponding to the principles of the present disclosure.

### BRIEF DESCRIPTION OF THE DRAWINGS

FIG. 1 illustrates an example cooperative computing environment.

FIG. 2 illustrates an example cooperative computing environment including a management gateway.

FIG. 3A illustrates an example confidential computing system configured to perform debugging techniques according to the principles of the present disclosure.

FIG. 3B illustrates an example debugging system according to the principles of the present disclosure.

FIG. 4 is a block diagram of an example computing device configured to implement functions of the systems and methods of the present disclosure.

FIG. 5 illustrates steps of an example method for performing debugging techniques in a confidential computing environment according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations. “A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In some examples, a computing environment is configured to be set up and operated by a single party or entity with full administrative power. If such an environment is used in collaborative or cooperative settings in which multiple entities contribute potentially sensitive or valuable digital assets (e.g., data, algorithms) to the overall system, the power of that single party to change the environment at any time in any way is problematic. For example, collaborating entities may not trust each other with respective intellectual property (IP), an entity with administrative power may now know assets (e.g., intellectual property) of other entities, etc. One established method for resolving this issue is to delegate the setup and operation of the computing environment (CE) to a trusted (third) party (TP). Trust extended to the TP is based on an assumption that the TP does not have interest in the digital assets that would create an incentive to extract or modify the digital assets, or the TP may be bound by various contracts or agreements not to disclose assets or other information. Further, capability of the TP to operate the environment in a secure way to prevent internal and external security threats is assumed.

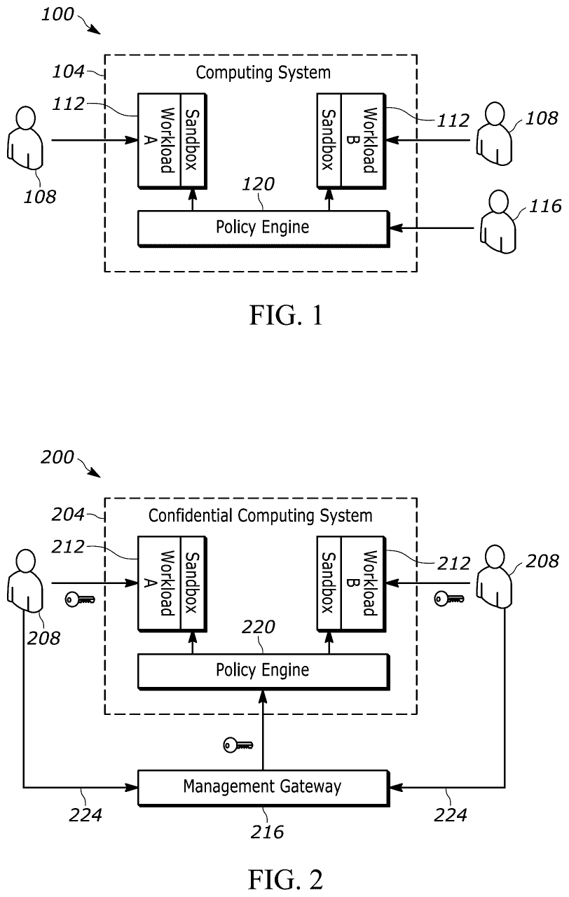

FIG. 1 illustrates an example cooperative computing environment (CE) 100. For example, the CE 100 includes a computing system 104 (e.g., a computing environment implemented in a cloud computing system, one or more servers or distributed computing devices, a computing cluster, etc.) accessible by multiple entities that are users or providers of digital assets within the CE 100, which, in some examples, may correspond to developer entities 108. The entities 108 may independently develop and test respective portions (e.g., workloads 112) of a software application within the computing system 104.

If one or more of the entities 108 contribute potentially sensitive or valuable digital assets to the computing system 104, it may not be desirable for any one of the entities 108 to control the CE 100. Accordingly, in some examples, the CE 100 is configured to be set up and operated by a single party or entity with full administrative access. For example a trusted third party (TP) 116 may be assigned full administrative privilege, which may include access to a policy engine 120 configured to control setup of the computing system 104, changes to the computing system 104 subsequent to setup, etc. In some examples, the trusted TP 116 may be one of the entities 108. However, trust extended to the TP 116 is based on an assumption that the TP 116 does not have interest in the digital assets that would create an incentive to extract or modify the digital assets. Further, capability of the TP 116 to operate the CE 100 in a secure way to prevent internal and external security threats must be assumed by the entities 108.

In some examples, advanced privacy-preserving computing techniques are used to establish a confidential CE (CCE) that provides a consensus-based setup and management mechanism for the CE that performs a management operation only if all contributing entities agree. These systems replace the trust-based operations model for multi-party CEs with a model that technically enforces the rules of cooperation within the CE and allows auditing of the enforcement process. Example systems and methods for establishing a confidential CE in this manner are described in more detail in U.S. patent application Ser. No. 18/594,777, filed 4 Mar. 2024, the entire contents of which are incorporated herein by reference.

For example, a mechanism is provided for setting up and operating a multi-owned computing environment (MOCE) (e.g., a CE that is set up and operated under the governance of more than one party/entity). The MOCE includes an interface for admitting the execution of management operations of a cluster (e.g., one or more build servers, computing devices, etc. used by multiple parties to implement a software build) only if a consensus among the owners of the environment is reached that an operation is permitted. Integrated policy engines implement versatile and flexible operation management (e.g., to define which operations can be performed and by which entities, in which circumstances, etc.). A sandboxing mechanism for workloads of the respective entities is executed within the MOCE and allows for tight control over what a workload is permitted to do (e.g., accessing other digital assets, opening network connections, etc.), and which resources the workload is permitted to consume (e.g., main memory, CPU/GPU time, etc.). The MOCE may further include a tamper-proof auditing mechanism to track which management operations have been performed by which entities (and when the management operations were performed) and a backup and recovery mechanism.

As used herein and described below in more detail, “CMI” refers to a consensus-driven management interface. “Participating party” (PP) refers to a party participating in a collaboration enabled by the principles of the present disclosure on the CE. The terms “party” and “entity” may be used interchangeably. A “computing environment” (CE) refers to the environment used by the PPs for collaboration, such as on a software build. Although described with respect to a collaboration for a software build, in other examples the principles of the present disclosure may be implemented for other types of collaborative CEs. A “hosting party (HP) refers to the party that instantiates the CE on its own or third-party infrastructure. “Trusted execution environment (TEE) refers to one example environment that is secure in accordance with confidential computing techniques that implement hardware protection techniques. A TEE provides the ability to establish trust in the TEE by a process called remote attestation (RA). A controller TEE is a TEE that hosts the control logic implementing the CMI and performs the management actions on the CE when consensus is reached. A controller TEE is implemented using one or more computing devices, processors or processing devices, etc. A “trusted multiparty build pipeline (TMBP) refers to a system that allows multiple parties to collaboratively integrate software modules in a trusted environment. A “build process” (BP) summarizes integration, build, test, and analysis steps of a software development process. A “confidential debugging system” (CDS) refers to an example system configured to implement the principles of the present disclosure. A “collaborative debugging process” (CDP) refers to a debugging process performed by/within the CDS.

Computing environments according to the present disclosure are configured to implement a consensus-driven management interface (CMI or CMMI) or consensus-driven management API (CAPI). A CMI or CAPI according to the present disclosure is an interface over which PPs can make a proposal or request for invoking a management functionality exposed over the interface. In an example embodiment, to set up the CE, the hosting party (HP) launches a TEE, referred to herein as the controller TEE (CTEE, or “controller in a trusted execution environment”), on a computing device or platform configured to provide the required confidential computing support. The computing device can be a public cloud provider, an on-premises datacenter (e.g., local to one or more of the entities), or combinations thereof. The CMI is implemented via a CTEE, which may be referred to as a management gateway.

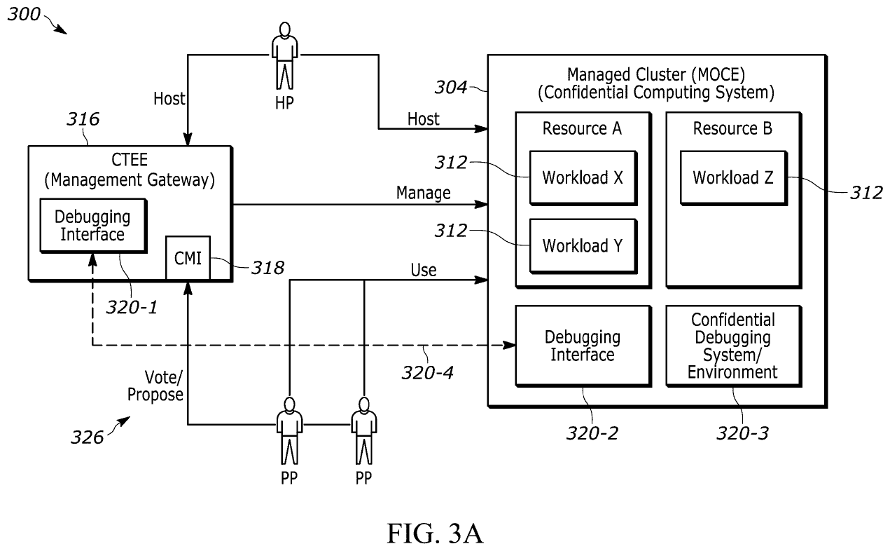

FIG. 2 illustrates an example cooperative computing environment (CE) 200 configured to implement a CMI. For example, the CE 200 includes a confidential computing system 204 (e.g., a computing environment implemented in a cloud computing system, one or more servers or distributed computing devices, a computing cluster, etc.) accessible by multiple developer entities (e.g., PPs, client computing devices, etc.) 208. The entities 208 may independently develop and test respective portions (e.g., workloads 212) of a software application within the computing system 204. In an example, the computing system 204 implements or is implemented by a confidential Kubernetes (K8s) cluster.

The CE 200 is configured to remove the need for a trusted TP by using advanced privacy-preserving computing techniques to establish an interface to the CE 200 that provides a consensus-based setup and management mechanism for the CE 200 that performs a management operation only if all contributing entities agree.

For example, the CE 200 is configured to implement a trusted, consensus-based management gateway 216. In an example, the management gateway 216 is configured to implement and/or operate in accordance with a TEE. The management gateway 216 is used to set up and operate the CE 200 (e.g., via management and control of policy engine 220). The computing system 204 is further configured to implement other components of the systems and methods described above, such as the operating system, controller software module, etc.

The management gateway 216 is configured to function as an interface for admitting the execution of management operations in the computing system 204 only if a consensus among the entities 208 is reached that an operation is permitted. In some examples, “consensus” may require agreement from all entities. In other examples, consensus may be achieved by agreement from a subset of all entities (e.g., a number of entities less than a total number of the entities), by reaching a threshold value (e.g., a threshold value corresponding to a combination of weighted votes or values from respective entities), etc. For example, the management gateway 216 (in communication with and responsive to the controller software module implemented on/by the computing system 204) is configured to implement all or portions of the CMI or CAPI described herein. Although shown separate from the computing system 204 (e.g., “off-cluster”), in other examples the management gateway 216 may be integrated with (e.g., located within) the computing system 204.

Accordingly, the management gateway 216 is configured to provide an interface over which the entities 208 can make a proposal or request for invoking a management functionality (e.g., via respective control paths 224). For example, any proposals or requests are provided from the entities 208 to the management gateway 216 and kept in a pending state until all (or a defined subset) of the entities 208 have approved the proposal in accordance with the systems and methods described herein.

In distributed software development, the process of integrating codebases may be referred to continuous integration (CI). CI allows issues to be detected and resolved while integrating the individual modules early in the development process. Typically, CI is not limited to the build process, but can additionally perform automated testing and code analysis (e.g., the build process, or BP) to ensure that the software modules and the final artifact align with the intended design and requirements.

When integration issues, test failures, or software bugs are identified, a common strategy to trace the issue to its origin is to debug the software. Software debugging is the systematic process of identifying, isolating, and rectifying defects, errors, or anomalies within a software artifact. Modern programming languages provide debugging interfaces and features like breakpoints, step-through execution, and variable inspection, trace inspection that assist developers in the debugging process described above. In a distributed development setting, where multiple parties debug an artifact collaboratively, the debugging process becomes more complex.

In some example systems, multiple parties can take control of a collaborative debugging session where all parties involved have independent access to the debugging session and relevant data. While the debugging session is initiated on a host system, the codebase is shared amongst all parties that can independently define debugging commands which are directed into the build and debugging instance. In these examples, the developers debugging a software artifact have direct access to the codebase or control over the debugging interface and therefore have access to all debugging information. However, in a scenario where multiple parties contribute confidential modules as input to the artifact that are substantial to the overall functionality as well as the integration and test results (e.g., such that it may be necessary for the individual parties to collaborate in the debugging process to isolate and fix the issue identified), it may be desirable to limit the access to the debugging session such that individuals can access only an agreed upon fraction of the debugging data generated. Other regulations, such as contractual conditions, may prohibit individual parties from debugging or accessing other parties'modules required for isolating the issue individually.

In some examples, a TMBP is provided for building software artifacts based on individual and potentially sensitive modules and providing functionality for running automated software tests and analysis to ensure that the resulting artifacts align with and meet the requirements of the intended design. When issues occur during a build process, developers may debug the build process or software artifacts to isolate the cause of the issue. However, in TMPB implementations (e.g., where individual components are protected from the access of others), participants cannot trace issues across borders of their own module.

Debugging techniques where the debugger (here a party that is debugging the software artifact) has only limited knowledge of (parts) of the software may be referred to as black box debugging. However, such techniques may prevent the developer from identifying or fixing some issues.

Debugging systems and methods according to the principles of the present disclosure (e.g., debugging systems and methods implemented in a confidential computing system/environment, such as the CE 200 shown in FIG. 2) are configured to enable multiple parties to perform a distributed and collaborative software debugging process to isolate issues across individual codebases such that the parties involved can access debugging data that relates to general debugging data or only individual software components. For example, as used herein, general debugging data is debugging data that relates to third party modules that are known or available to all parties involved or modules that have been approved for general access by the contributing party.

The debugging systems and methods described herein are configured to allow multiple parties to collaboratively debug a software artifact such that the participating parties (PP) can identify issues together even if some potentially sensitive sources of the artifact are accessible by only a subset of the parties. In some examples, a debugging system according to the present disclosure may be referred to as a confidential debugging system (CDS). The CDS provides mechanisms to limit access to the debugging session or filter the debugging information disclosed to the PPs to ensure the confidentiality of critical information (e.g., information associated with intellectual property) within the source code or the source code itself. The access limitations and filtering of the debugging information is based on defined policies agreed on between the PPs using a consensus mechanism, derived from information of a source control system, or generated from code-and configuration-based attributes. In order to ensure confidentiality of the input from individual parties and the integrity of the introduced system, the CDS may be deployed using confidential computing mechanisms configured to enable individual parties to verify the deployment using technical measures (e.g., remote attestation).

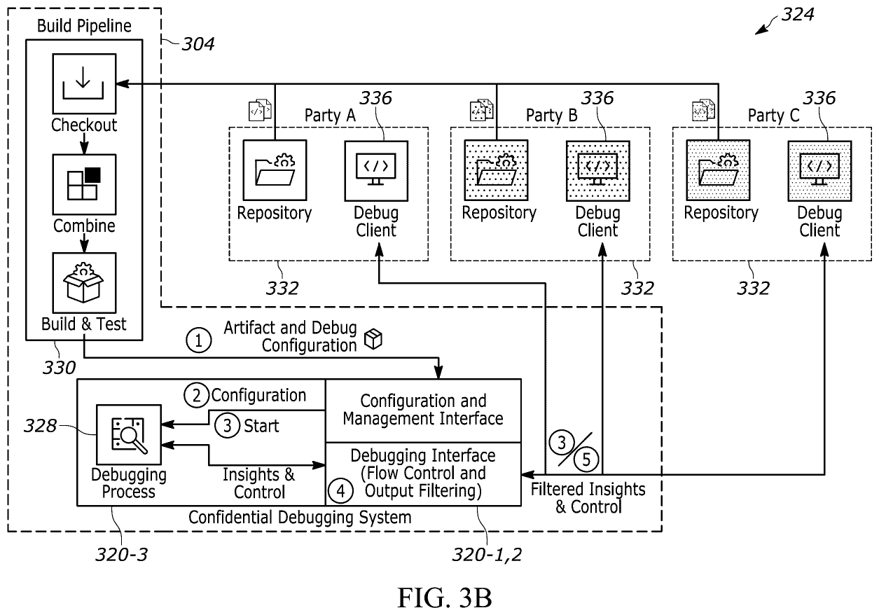

FIG. 3A illustrates an example CE 300 configured to implement debugging techniques (e.g., debugging systems and/or methods) according to the principles of the present disclosure. The CE 300 may be generally configured in a manner similar to the CE 200 of FIG. 2. Some elements shown in FIG. 2 are omitted from FIG. 3 for simplicity. For example, the CE 300 includes a confidential computing system 304 accessible by multiple developer entities (e.g., PPs, client computing devices, etc.). For example, different portions (e.g., workloads 312 associated with respective resources A, B, etc.) of a software application within the computing system 304 may be independently accessed by respective entities for developing and testing. In an example, the computing system 304 implements or is implemented by a confidential Kubernetes (K8s) cluster. Accordingly, the computing system 304 may be referred to as an MOCE, and the terms computing system and MOCE may be used interchangeable in the context of the system 304. In some examples, the CE 300 is used to implement a build process/pipeline to build software subsequently debugged in accordance with the principles of the present disclosure. In other examples, a build pipeline can be implemented external to the CE 300 (e.g., within another CE) to build software that is subsequently transferred to the CE 300 for debugging.

The CE 300 includes a CTEE 316 configured to host/execute control logic for implementing a CMI 318. In some contexts, functionality of the CTEE 316 may be referred to as a management gateway (e.g., a trusted, consensus-based management gateway configured to implement and/or operate in accordance with a TEE). The CTEE 316 according to the present disclosure is configured to execute/implement all or portions of a debugging system, module, or agent 320 as described below in more detail. All or portions of a debugging system may be implemented by the CTEE 316 (a debugging interface 320-1), the MOCE 304 (e.g., a debugging interface 320-2 and confidential debugging environment 320-3), etc., each of which may be referred to as a confidential debugging system (CDS) 320 (individually or collectively) for simplicity. The debugging interfaces 320-1 and 320-2 may be connected by a virtual communication link 320-4. In some examples, a debugging interface may only be implemented on one of the CTEE 316 and the MOCE 304 or may be implemented external to both the CTEE 316 and the MOCE 304. Further, each of the PPs may access/interact with the debugging system 320 via respective debugging interfaces/agents/clients (e.g., implemented on computing devices, interfaces, etc. associated with the respective PPs). The debugging interfaces 320-1 and 320-2 provide APIs that can be used by the PPs to access to the CDS 320.

FIG. 3B (with continued reference to FIG. 3A) shows an example debugging system 324 according to the principles of the present disclosure. The debugging system 324 includes one or more components/elements implemented by various components of the CE 300, such as elements implemented by the debugging interface 320. All or portions of the debugging system 324 can be implemented by the MOCE 304 (e.g., the confidential debugging environment 320-3) and/or the CTEE 316 (e.g., the debugging interface 320-1), with some functions implemented by/on computing devices of the respective PPs (e.g., a user interface configured to present/display portions of software/code accessible by a respective user, receive inputs communicated to the CE 300, etc.).

In this example, the debugging system 324 includes the collaborative, confidential debugging system (e.g., CDS) 320. The CDS 320 as shown schematically in FIG. 3B may represent all or a portion of the debugging functions performed by the CE 300 in accordance with the principles of the present disclosure. For example, the CDS 320 may include/implement the functionality of the debugging interfaces 320-1 and 320-2 as implemented by the CTEE 316 and the MOCE 304, respectively, and the confidential debugging environment 320-3 implemented within the MOCE. Similarly, a build pipeline 330 may be implemented within/by the CE 300 in accordance with confidential computing techniques as described herein.

Conversely, one or more PPs authorized to participate in build and debugging processes are shown at 332. The PPs 332 interface with the CE 300 via respective debug/debugging clients 336. For example, the PPs 332 use the clients 336 to step through accessible portions of source code for debugging (without seeing/being presented with source code associated with others of the PPs 332). Collaborative debugging of software artifacts using the CDS 320 (where debugging information is disclosed only to a subset of the PPs 332) is described below in more detail.

The debugging techniques of the present disclosure are described in the context of a scenario where multiple parties provide individual modules to a BP (e.g., corresponding to the build pipeline 330). Once individual software modules (as provided by the respective PPs 332) have been integrated into a final artifact, a collaborative debugging process to identify the cause of and fix a software bug identified by a failed test is started. Any limitation to this scenario is merely for reasons of presentation and does not limit the general applicability of the debugging techniques described herein.

A debugging method/process for debugging a collaboratively built artifact (e.g., a “collaborative debugging process,” or CDP) according to the present disclosure may be initiated subsequent to the software build being completed (or, in some examples, partially completed) as shown at 1 in FIG. 3B. Initiation of the debugging process (shown schematically at 328) can be performed manually (e.g., by a single PP 332 that initiates the debugging process by interacting with an API of the CDS 320, such as implemented by the debugging client 336) and/or automatically (e.g., in response to an issue, such as an error indicated by build pipeline 330, being is identified). The initiator may provide parameters to configure and describe the CDP, such as a BP log, as well as the build artifact and/or a reference to the build artifact.

The build artifact is loaded into the CDS 320 (e.g., via a configuration and management interface) as shown at 2. In this step, the CDP is initialized, allowing all defined parties to connect to the process via the API of the CDS 320. The CDS 320 may be configured to use standard mechanisms for authentication and authorization, well known in literature, for example certificate based authentication, to manage access to the CDS 320 (e.g., by integrating with external tools, by implementing the required functionality within the CDS 320, etc.). The PPs 332 having access to the CDP may be defined by different techniques, including, but not limited to: i) explicitly (manually) defined (e.g., in a configuration of the CDP); ii) derived from a list of code owners who have uploaded an individual module to the shared codebase used for the BP. The “term code owner” describes the PP that has contributed specific parts, such as modules or source files, of the shared codebase; iii) derived from the list of code contributors, potentially extracted from source code management system (e.g., such as with git blame annotations); and/or iv) based on information defined in the build and test pipeline configuration, such as a hard-coded list of PPs, a set of rules or other logic that is evaluated to retrieve a list of PPs, etc.

Once all of the PPs defined in this manner have connected to the CDP, the debugging process can be started as shown at 3. In some examples, all (or an agreed upon quorum of) connected parties may be required to indicate that they are ready to start the debugging process. The CDP may also provide options to define a threshold or provide a list of identifiers of the required parties to start the debugging process.

The CDS 320 distributes generated debugging information to the connected PPs 332 (e.g., via a debugging interface, implemented by the CDS 320 and, in part, by the respective debugging clients 336) as shown at 4. The debugging information is filtered on a per-recipient basis to protect sensitive information. In other words, each of the PPs 332 is provided only with respective portions of the information, source code, etc. needed to perform respective portions of the debugging process. The filtering may be applied on all or only parts of the debugging information such as a trace log, a state of components, field values, etc. The filtering of the debugging information may be based on different options such as described below in more detail.

The PPs 332 collaboratively debug respective portions of the build artifact to identify the cause of the issue as shown at 5. Collaborative debugging may require additional communication channels for information exchange provided by the CDP itself, by integrating third party tools such as chats, voice and video conferencing tools, etc.

Providing debugging input and managing of debugging flow according to the principles of the present disclosure may include various functions or features. For example, the configuration of the debugging process (e.g., such as breakpoint definitions or program arguments) can either be defined as part of the configuration of the CDP and/or during execution of the CDP (e.g., using an API implemented by the CDS 320). The CDS 320 may apply additional filtering to the configuration to prevent access to modules or information other than those the interacting party has access to (e.g., to prevent an individual PP from setting breakpoints on modules that are owned by another one of the PPs 332).

Since the CDS 320 is configured to control the debugging information shared with individual parties, the CDS 320 can prevent and interrupt PPs from accessing information outside of their respective allowed/permitted control. For example, one example scenario may include an individual PP defining a breakpoint and then starting a step-through debugging process once the breakpoint is reached. While stepping through the code, the PP may reach a point where a method is called/invoked that is implemented by another PP who has not granted others of the PPs 332 access to the respective sources. The flow of the initial PP may be interrupted or paused while the control of the debugging flow is handed over to another party who has access to the relevant sources processed. While the debugging process is on hold for individual parties, filtering of debugging information is applied as configured by the CDP. If multiple PPs have started an individual step-through debugging process, individual parties may nevertheless receive different debugging information with each step according to the defined debug filtering as described below in more detail.

As shown at steps 3 and 4 of the workflow of FIG. 3B, the CDS 320 starts the debugging process and distributes the debugging information generated by the process. The CDS 320 may implement the debugging functionalities itself and provide the information as well as control over the flow via a dedicated API. In another embodiment, the CDS uses various well known debugging tools for the programming language being used. Since these debugging tools may be tightly integrated into modern integrated development environments (IDEs), the CDS 320 may be configured to implement the API of the used debugging tool to enable a direct integration into the IDEs acting as a proxy. Nevertheless, both utilizing standard debugging tools and implementing a standard debugging API of a given programing language can be applied individually.

In one example, a proxy module can be used to intercept and process the data generated by the debugging process within the IDE. This approach may involve a third-party tool that implements the API of the debugging tool to filter and process the data, providing additional analysis and insights into the debugging process. The scenario where the CDS 320 uses a standard debugging tool and acts as a proxy to third party tools such as IDEs can be described as follows:

Intercepting debugging data: the CDS 320 acts as a proxy, intercepting the data generated by the debugging process using a standard debugging tool to debug an application. This data may include information about the program's execution, variable values, call stacks, and other relevant details;

Implementing the API of the debugging tool: the CDS 320 implements the API of the debugging tool used. This allows seamless integration with IDEs and third-party tools;

Filtering and processing data: once the debugging data is intercepted, the CDS 320 filters and processes the information to prevent access from unauthorized parties or provide additional analysis and insights. This may involve aggregating and visualizing the data, identifying patterns or anomalies of unauthorized access, and extracting relevant metrics for further analysis; and

Forwarding processed data to the PPs 332: after the debugging data is filtered and processed, the resulting data is sent to all eligible PPs. This may involve presenting the processed data through the IDE's interface, generating reports or logging events to an auditing system, and/or sending notifications to the developer with relevant information.

Disclosure of filtered debugging information as shown at 4 in FIG. 3B may be performed as follows. The CDS 320 may filter the distributed debugging information based on defined rules. For example, the CDS 320 may be configured such that only those PPs who have contributed to the currently processed sources receive the shared information. However, an individual PP that has received filtered debugging information may decide that it would be beneficial to share the information received with other PPs as well (e.g., to request support, share specific information about the application state in general, etc.). As an extension to the filtering step, an individual PP who is currently in control of the debugging workflow can decide to disclose a current debugging state and relevant information to additional PPs that do currently not have access to that information. In order to support this scenario, the CDS 320 may provide additional information about which other PPs received the information when forwarding potentially processed debugging information to an individual PP of the CDP. Individual PPs can then decide whether the information can be shared with all or only a subset of the PPs that did not receive the information initially. If the information was initially distributed to multiple (but not all) PPs, additional sharing of information may require consensus by all PPs that initially received the information.

In some examples, the debugging process may include hot reloading features. For example, when a PP identifies a potential bug during a CDP, the PP may want to update the source code and test changes immediately, or one or more PPs may want to re-run a debugging flow with new input parameters to the application. The CDP may therefore provide functionality to automatically merge and apply software changes by individual PPs and/or restart an active CDP with a new set of input parameters. Such a reload/restart may require consensus of all PPs of the CDP.

In some examples, the debugging process may include trust-establishing features. For example, even though the CDS 320 can be deployed and used without additional security measures, the PPs may want to ensure the integrity and confidentiality of the CDS 320 to protect sensitive information. Therefore, the CDS 320 may be deployed using CC mechanisms to allow PPs to verify the integrity of the CDS 320 using RA as described herein. When the CDS 320 is integrated into other processes such as a CI pipeline (e.g., a CI pipeline based on TMBP), the integrating party can use RA to attest the integrity of the CDS 320 before providing sensitive data as an input to the system.

In some examples, systems and methods according to the present disclosure may implement consensus-based initiation techniques. For example, the collaborative CDP using the CDS 320 may not be initiated by a single entity (e.g., a single process or individual) but instead may require consensus of all or a subset of the PPs 332 contributing to the collaborative codebase. Such a mechanism can be integrated by leveraging the functionalities provided by a CTEE or be part of the CDS 320 itself.

In some examples, systems and methods according to the present disclosure may implement replay debugging techniques. For example, as an alternative to the collaborative debugging workflow process described above, the CDS 320 may not initiate and start a new debugging process but instead may replay and distribute recorded debugging session data. In an example scenario where a test case is generating inconsistent results (a so-called “flaky” test), or the artifact behaves differently in different (e.g., different hardware or software) environments, recording debugging session data and replaying the debugging session at a later time (or, repeatedly) can facilitate isolating the cause of the issues. This approach can be applied to debugging session data that is, for example, (i) recorded by one of the PPs 332, which can then be provided as an input to the configuration of the CDP for collaborative debugging using the functionality described herein, (ii) recorded during build and test pipeline runs, and/or (iii) generated by the CDS 320 itself based on the defined artifact and a description of the issue that occurred.

In some examples, systems and methods according to the present disclosure may implement debugging access restriction techniques (e.g., using code markup). For example, the debugging system 324 may include libraries in different programming languages and definitions of markup tags (or decorator tags). The tags define different levels of permissions that may be applied to segments of the code (e.g., UNRESTRICTED, RESTRICTED, STEP_IN_ALLOWED, VAR_ACCESS_ALLOWED, etc.). The PPs 332 may use the tags/decorators compatible with the programming language in the source code to define fine grained restrictions on code segments and files. The CDP parses the code decorators and enforces the restrictions via the API for different PPs. For example, code within the UNRESTRICTED boundary may allow any authenticated PP to use the CDP API to set breakpoints within the boundaries and observe the variables. A segment with RESTRICTED but VAR_ACCESS_ALLOWED tag may disallow setting of breakpoints but allow observation of the variable states.

In some examples, systems and methods according to the present disclosure may implement temporary debugging access privilege escalation flow techniques. For example, the CDP can support allowing authenticated PPs to create proposals for temporary privilege escalation or code access. A CDP access proposal includes, for example, the desired capabilities (e.g., variables reading, breakpoint insertion, etc.), code segment (specified as code regions or function names), ID of the requestor, a reason for the request, etc. The CDP identifies the owner of the code segment based on analysis of the source code and sends the access request to the owner PP. The owner has the ability to use the CDP API to accept or deny the request, resulting in a unique decision ID. Upon approval, the CDP API allows the additional access to the requesting PP until the end of the debugging session. The owner PP may revoke an approved access by issuing a special command to the CDP API and specifying the decision ID.

In some examples, systems and methods according to the present disclosure may implement AI-assisted collaborative debugging techniques. For example, in the context of collaborative debugging with distrustful parties, the availability of other parties and lack of visibility into code owned by other parties can impact the efficiency of the debugging process. Generative AI models can be used for assistance with coding and debugging activities. In an example, an AI coding assistant running inside a TEE can be permitted access to the state of the debugged program. The AI coding assistant can potentially understand the code modules supplied by various parties and have access to the runtime state of the program, including information such as call stack, values of variables, and so on. Therefore, the AI coding assistant could play the role of a proxy for another party to assist with debugging. With information about the inputs to and outputs from the code of another party, the AI coding assistant can flag a bug in the code. The AI coding assistant can be trained to reveal useful information relevant to debugging a defect without disclosing any details of the code or the mode of failure that will give any insight into the software of another party. Further, the AI coding assistant can be used to suggest fixes for potential bugs in the code or propose code that would improve the performance of the program. For example, the AI coding assistant can have more insight into neighboring code that otherwise cannot be revealed to individual parties in collaborative debugging.

Appropriate guardrails can be established so that the AI coding assistant does not inadvertently leak information through malicious prompts. The filter of the CDS 320 can intercept both the inputs to and outputs from the AI coding assistant to further reduce the risk of compromising another the software assets of another party.

In some examples, systems and methods according to the present disclosure may be configured to facilitate debugging of data-dependent programs. The behavior of some programs can be highly dependent on the data being processed by the respective programs. The data itself might be owned by a separate entity (e.g., a data owner (DO). This separate entity/party may not want to reveal the content of data that is being used during debugging to PPs that own the code segment. In such cases a consensus to share debugging information of both code owner and the DO may be necessary. Alternatively, the data being used while sharing debugging information with a code owner could be anonymized and/or a separate non-sensitive dataset can be used. This is especially important for AI systems, where data is a valuable asset.

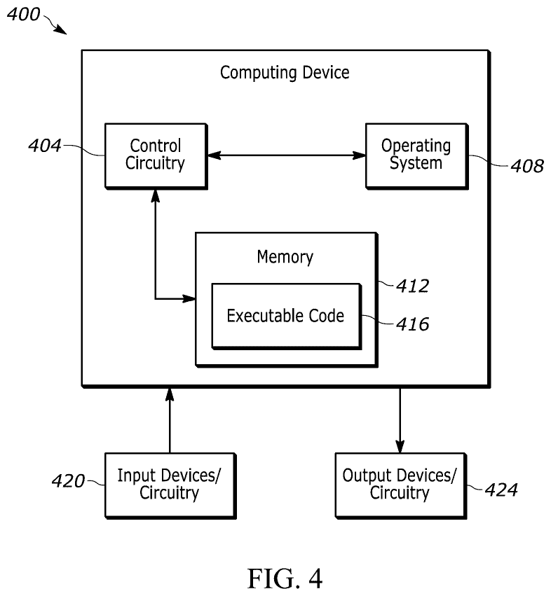

FIG. 4 shows a block diagram of an example computing device 400 configured to implement functions of the systems and methods described herein according to the present disclosure. For example, one or more of the computing devices 400 may implement or be implemented by the one or more components of the CE 300. Systems described herein may implement a single computing device, a plurality of computing devices, etc., configured to individually and/or collectively perform functions related to the systems and methods of the present disclosure. In an example, the CTEE 316 and/or the MOCE/computing system 304 may implement or include one or more of the computing devices 400.

The computing device 400 may include control circuitry 404 that may be, for example, one or more processors or processing devices, a central processing unit processor (a, CPU, such as a CPU configured to operate a protected memory space in accordance with a TEE), an integrated circuit or any suitable computing or computational device, an operating system 408, a memory 412, executable code 416, input devices or circuitry 420, and output devices or circuitry 424. The control circuitry 404 (or one or more controllers or processors, possibly across multiple units or devices) may be configured to implement functions of the systems and methods described herein. More than one of the computing devices 400 may be included in, and one or more of the computing devices 400 may act as the components of, a system according to embodiments of the disclosure. Various components of the computing device 400 may be implemented with same or different circuitry, same or different processors or processing devices, etc.

The operating system 408 may be or may include any code segment (e.g., one similar to the executable code 416 described herein) designed and/or configured to perform tasks involving coordination, scheduling, arbitration, supervising, controlling or otherwise managing operation of the control circuitry 404 (e.g., scheduling execution of software programs or tasks or enabling software programs or other hardware modules or units to communicate). The operating system 408 may be a commercial operating system. The operating system 408 may be an optional component (e.g., in some embodiments, a system may include a computing device that does not require or include the operating system 408). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 412 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 412 may be or may include a plurality of memory units, which may correspond to same or different types of memory or memory circuitry. The memory 412 may be a computer or processor non-transitory readable medium, or a computer non-transitory storage medium, e.g., RAM.

The executable code 416 may be any executable code, e.g., an application, a program, a process, task, or script. The executable code 416 may be executed by the control circuitry 404, possibly under control of the operating system 408. Although, for the sake of clarity, a single item of the executable code 416 is shown, a system according to some embodiments of the disclosure may include a plurality of executable code segments similar to the executable code 416 that may be loaded into the memory 412 and cause the control circuitry 404 to carry out methods described herein. Where applicable, the terms “process” and “executable code” may be used interchangeably herein. For example, verification, validation and/or authentication of a process may mean verification, validation and/or authentication of executable code.

In some examples, the memory 412 may include non-volatile memory having the storage capacity of a storage system. In other examples, the computing device 400 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 412 where it may be processed by the control circuitry 404.

The input circuitry 420 may be or may include any suitable input devices, components, or systems, e.g., physical sensors such as accelerometers, thermometers, microphones, analog to digital converters, etc., a detachable keyboard or keypad, a mouse, etc. The output circuitry 424 may include one or more (possibly detachable) displays or monitors, motors, servo motors, speakers and/or any other suitable output devices. Any applicable input/output (I/O) devices may be connected to the control circuitry 404. For example, a wired or wireless network interface card (NIC), a universal serial bus (USB) device, or external storage device may be included in the input circuitry 420 and/or the output circuitry 424. It will be recognized that any suitable number of input devices and output devices may be operatively connected to the control circuitry 404. For example, the input circuitry 420 and the output circuitry 424 may be used by a technician or engineer in order to connect to the control circuitry 404, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 412, computer-executable instructions such as the executable code 416, and a controller such as the control circuitry 404.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 404), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 404.

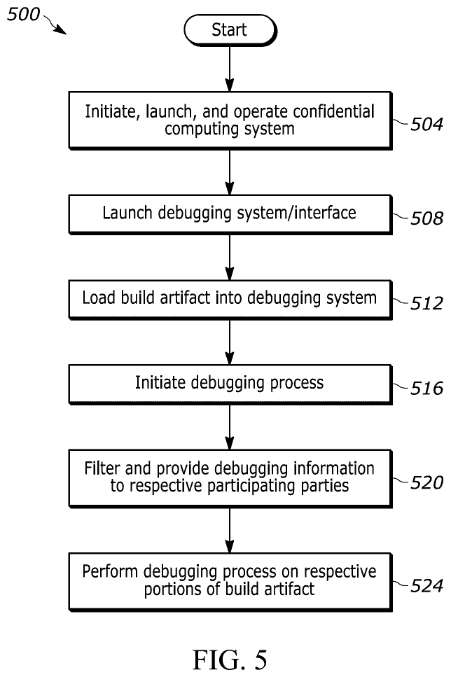

FIG. 5 illustrates steps of an example method 500 for performing debugging techniques in a confidential, cooperative computing environment according to the principles of the present disclosure. For example, one or more computing devices, processors or processing devices, etc. are configured to execute instructions to implement the method 500, such as one or more of processors of the systems described herein. In an example, the CE 300 implements all or portions of the method 500.

At 504, the method 500 includes initiating and operating a confidential computing environment/system to facilitate cooperative computing. For example, a TEE is launched on a confidential computing system, an interface (e.g., an API, CMI, etc. as described herein) is executed to provide access for management functionality to PPs (e.g., via a management gateway), a setup process is initiated, assessed, and approved by PPs, and a build process is launched to being operation of a confidential computing system (e.g., a managed cluster/MOCE). In some examples, all or portions of the build process may be launched and performed external to the confidential computing system and the completed or partially completed build artifact can be subsequently transferred to the confidential computing system for debugging

At 508, the method 500 includes launching/executing all or portions of a debugging system and interface (e.g., the CDS 320) on the confidential computing system. For example, the CDS 320 as described herein is located and executed within the CE 300 but some functions/components of the debugging system may be implemented at computing devices associated with respective PPs (e.g., the debugging clients 336). As one example, the debugging clients 336 may include a communication and/or display interface configured to receive inputs from a user and output/display information to the user. In this manner, the debugging system 320 is executed within the CE 300 but individual PPs can use the debugging clients 336 to view code (e.g., respective code portions that the PPs are permitted to view), step through the code, etc.

At 512, the method 500 includes loading the build artifact into the debugging system (e.g., into the CDS 320). Loading the build artifact may further include enabling the PPs to access respective portions of the build artifact (e.g., via the debugging clients 336).

At 516, the method 500 includes initiating a debugging process (e.g., a CDP as described herein). The CDP may be automatically initiated by the CDS 320 (e.g., upon completion or partial completion of a build artifact, in response to a request from one or more of the PPs (e.g., via a respective one of the debugging clients 336), in response to an issue or error being detected during execution of the build process, etc.

At 520, the method 500 includes providing debugging information/data to respective PPs (e.g., via the debugging clients 336). Providing the debugging information includes providing, to each of the PPs, only portions of the debugging information, source code, etc. needed by the respective PPs to perform debugging on their respective portions of the source code/build artifact. In other words, the debugging information is filtered and provided on a per-recipient basis.

At 524, the method 500 includes performing, by each of the respective PPs, the collaborative debugging process. In other words, each of the respective PPs debugs respective portions of the build artifact (e.g., by stepping through the source code via the debugging clients 336).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The various steps and logic performed herein can be executed with non-volatile storage, memory, and processors. Non-volatile storage may include one or more persistent data storage devices such as a hard drive, optical drive, tape drive, non-volatile solid-state device, cloud storage or any other device configured to persistently store information. Processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device configured to store information.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A system configured to perform a collaborative debugging process in a multi-owned computing environment (MOCE), the system comprising:
one or more computing devices configured to
establish a confidential computing system using a trusted execution environment (TEE), the confidential computing system storing at least a portion of a software build artifact,
initiate, by a debugging system on the confidential computing system as established in the TEE, the debugging process, wherein the debugging process is configured to enable debugging of the software build artifact by a plurality of participating parties (PPs), wherein each of the PPs is associated with a different portion of the software build artifact, and
execute the debugging process using the debugging system on the confidential computing system, wherein executing the debugging process includes
providing, from the debugging system on the confidential computing system, respective portions of debugging information to the PPs via respective debugging client interfaces, wherein each of the respective portions of the debugging information is associated with a respective different portion of the software build artifact, and
receiving, at the debugging system from the respective debugging client interfaces, inputs associated with the debugging process being performed on the respective portions of the debugging information.

2. The system of claim 1, wherein the one or more computing devices are further configured to:
establish a second confidential computing system external to the MOCE;
establish the confidential computing system in the second confidential computing system; and
establish a secure channel between the MOCE and the second confidential computing system using remote attestation.

3. The system of claim 1, wherein initiating the debugging process includes at least one of:
initiating the debugging system in response to an input from one or more of the PPs; and
initiating the debugging process, the confidential computing system, in response to detecting an error in the software build artifact.

4. The system of claim 1, wherein initiating the debugging process includes initiating the debugging system in response to receiving a notification from a PP;
sending information about the debugging system to a plurality of PPs;
receiving, from a plurality of PPs, a response confirming participation in the debugging process; and
in response to determining that a number of the PPs providing the response is greater than a predetermined threshold, initiating the debugging process.

5. The system of claim 1, wherein providing the respective portions of the debugging information includes filtering the debugging information on a per-recipient basis and transmitting the filtered debugging information at the respective debugging client interfaces.

6. The system of claim 1, wherein the one or more computing devices are further configured to:
store, within the confidential computing system, data associating each of the PPs with the respective different portions of the software build artifact; and
in response to a request from a first PP to access data associated with a second PP, send an error message to the first PP.

7. The system of claim 1, wherein the one or more computing devices are further configured to:
receive a request from a first PP to access a portion of the software build artifact associated with a second PP;
receive authorization from the second PP to allow the first PP to access the portion of the software build artifact associated with the second PP; and
provide, to the first PP, debugging information associated with the portion of the software build artifact associated with the second PP.

8. The system of claim 1, wherein receiving the inputs associated with the debugging process includes receiving step-through debugging inputs.

9. The system of claim 1, wherein the debugging system further comprises:
a programming language specific debugging tool; and
an API interface providing access to the debugging tool, wherein
the API interface applies filtering to debugging information transmitted from the system, and
the API interface applies filtering to debugging information received by the system.

10. The system of claim 1, wherein the one or more computing devices are further configured to:
record debugging session data;
store the recorded debugging session data by encrypting the recorded debugging session data in a storage location external to the debugging system; and
upon configuration of a new debugging session with the recorded debugging session data, replay the recorded debugging session data.

11. The system of claim 1, wherein the one or more computing devices are further configured to:
store, in a code repository, markup tags that define different levels of permission assigned to respective segments of the software build artifact; and
use the markup tags to configure filters and boundaries based on the markup tags to generate configuration information; and
provide, from the debugging system, the debugging information based on the configuration information.

12. The system of claim 1, wherein the debugging system further includes an artificial intelligence (AI) model configured to perform debugging functions as a first PP, wherein the one or more computing devices are further configured to:
receive, from a second PP, inputs containing debugging information of a code component associated with the second PP; and
send, to a third PP, outputs required to debug a code component associated with the third PP.

13. The system of claim 1, wherein the debugging system includes is configured to use the debugging information to apply corrections to build sources, wherein the one or more computing devices are further configured to:
launch a second build process in the MOCE to obtain a second software build artifact; and
replace the debugging process using the software build artifact with a second debugging process using the second software build artifact.

14. The system of claim 1, wherein the one or more computing devices are further configured to:
upon launching the debugging system, start, by a first PP, a remote attestation process with the debugging system to receive an attestation result; and
upon inspection of a successful attestation result, share confidential data with the debugging system.

15. A method for performing a collaborative debugging process in a multi-owned computing environment (MOCE), the method comprising, using one or more computing devices:
establishing a confidential computing system using a trusted execution environment (TEE), the confidential computing system storing at least a portion of a software build artifact;
initiating, by a debugging system on the confidential computing system as established in the TEE, the debugging process, wherein the debugging process is configured to enable debugging of the software build artifact by a plurality of participating parties (PPs), wherein each of the PPs is associated with a different portion of the software build artifact; and
executing the debugging process using the debugging system on the confidential computing system, wherein executing the debugging process includes
providing, from the debugging system on the confidential computing system, respective portions of debugging information to the PPs via respective debugging client interfaces, wherein each of the respective portions of the debugging information is associated with a respective different portion of the software build artifact, and
receiving, at the debugging system from the respective debugging client interfaces, inputs associated with the debugging process being performed on the respective portions of the debugging information.

16. The method of claim 15, further comprising:
establishing a second confidential computing system external to the MOCE;
establishing the confidential computing system in the second confidential computing system; and
establishing a secure channel between the MOCE and the second confidential computing system using remote attestation.

17. The method of claim 15, wherein initiating the debugging process includes at least one of:
initiating the debugging process in response to an input from one or more of the PPs; and
initiating the debugging process, the confidential computing system, in response to detecting an error in the software build artifact.

18. The method of claim 15, wherein initiating the debugging process includes initiating the debugging system in response to receiving a notification from a PP, the method further comprising:
sending information about the debugging system to a plurality of PPs;
receiving, from a plurality of PPs, a response confirming participation in the debugging process; and
in response to determining that a number of the PPs providing the response is greater than a predetermined threshold, initiating the debugging process.

19. The method of claim 15, wherein providing the respective portions of the debugging information includes filtering the debugging information on a per-recipient basis and transmitting the filtered debugging information at the respective debugging client interfaces.

20. The method of claim 15, further comprising:
receiving a request from a first PP to access a portion of the software build artifact associated with a second PP;
receiving authorization from the second PP to allow the first PP to access the portion of the software build artifact associated with the second PP; and
providing, to the first PP, debugging information associated with the portion of the software build artifact associated with the second PP.
